(19) United States
(12) Patent Application Publication
(10) Pub. No.: US 2005/0042943 A1
(43) Pub. Date: Feb. 24, 2005

(54) Method and arrangement for the rapid connection and detachment of connectable elements

(76) Inventors: Josef Mocivnik, Fohnsdorf (AT); Emile Lonardi, Bascharage (LU)

Correspondence Address: JACOBSON HOLMAN PLLC, 400 SEVENTH STREET N.W., SUITE 600, WASHINGTON, DC, 20004, US

(21) Appl. No.: 10/960,005

(22) Filed: Oct. 8, 2004

Related U.S. Application Data
(63) Continuation of application No. PCT/AT03/00152, filed on May 27, 2003.

(30) Foreign Application Priority Data
Jun. 7, 2002 (AT) A 871/2002

(51) Int. Cl. H01R 9/22

(52) U.S. Cl. 439/894

(57) ABSTRACT

In a method and an arrangement for the rapid connection and detachment of connectable elements (4, 6), particularly tubes or rods and/or driving elements and/or working elements capable of being fixed thereto such as, for instance, drill bits or the like, wherein an element (4) having a profiled end piece (9) is introduced into a respective reception opening (11) of the element (6) to be connected therewith and/or an intermediate or connection piece (7), particularly a bushing or sleeve, and connected with the second element (6) in a positive and force-transmitting manner, it is provided that, for the connection and detachment of the two elements (4, 6) to be connected, the profiled end piece (9) after a movement in the axial or connection direction (12) is rotated, by a partial region (15) of the reception opening (11) provided with a profile complementary to that of the end piece, relative to the reception opening (11) in a partial region (13) of the reception opening (11) having an enlarged clear cross section, and subsequently is again moved in the axial direction (12) into a further partial region (10) of the reception opening (11) provided with a profile complementary to that of the end piece (9), thus enabling rapid and simple connection and detachment at structurally simple expenses.

The present application is a continuation application of PCT/AT03/00152, filed on May 27, 2003.

### FIELD OF THE INVENTION

The present invention relates to a method for the rapid connection and detachment of connectable elements, particularly tubes or rods and/or driving elements and/or working elements capable of being fixed thereto such as, for instance, drill bits or the like, wherein an element having a profiled end piece is introduced into a respective reception opening of the element to be connected therewith and/or an intermediate or connection piece, particularly a bushing or sleeve, and connected with the second element in a positive and force-transmitting manner. The invention, furthermore, relates to an arrangement for the rapid connection and detachment of connectable elements, particularly tubes or rods and/or driving elements and/or working elements capable of being fixed thereto such as, for instance, drill bits or the like, wherein an element having a profiled end piece is introducible into a respective reception opening of the element to be connected therewith and/or an intermediate or connection piece, particularly a bushing or sleeve, and connectable with the second element in a positive and force-transmitting manner, as well as to the use of such an arrangement.

### DESCRIPTION OF THE PRIOR ART

In the context of connecting and detaching connectable elements such as, for instance, tubes or rods, there is often the problem of rapidly detaching and connecting such elements or driving elements and/or working elements to be connected therewith, such a rapid connection or detachment, if necessary, having to be reliably feasible or realizable even under rough and adverse environmental conditions. In the context of the production of bore holes, for instance, the extension of a drill rod assembly is frequently necessary, wherein known screw connections not only call for time-consuming connecting and detaching procedures, but such screw connections may entail problems relating to the proper connection or proper detachment of such a connection, particularly under rough conditions of use. Furthermore, it must be safeguarded, for instance in the production of a tap hole at a blast furnace by means of a tap-hole drilling machine, that during the emergence of the molten mass, which has a high temperature, at least parts of the drill rod assembly and, in particular, the driving means can be detached from the drill rod assembly in a sufficiently quick manner so as to enable the removal of at least the drilling machine from the region of the emerging high-temperature molten mass.

### SUMMARY OF THE INVENTION

The invention aims to provide a method and an arrangement for the rapid connection and detachment of connectable elements, which enable the reliable and rapid connection and detachment of mutually connected elements, for instance tubes or rods and/or driving elements and/or working elements capable of being fixed thereto, even under possibly rough and adverse utilization or environmental conditions.

To solve these objects, the method according to the invention, departing from a method of the initially defined kind, is essentially characterized in that, for the connection and detachment of the two elements to be connected, the profiled end piece after a movement in the axial or connection direction is rotated, by a partial region of the reception opening provided with a profile complementary to that of the end piece, relative to the reception opening in a partial region of the reception opening having an enlarged clear cross section, and subsequently is again moved in the axial direction into a further partial region of the reception opening provided with a profile complementary to that of the end piece. By effecting a multi-step relative movement between the elements to be connected, particularly between the profiled end piece of an element and a reception opening of a second element, a reliable and safe connection between the two elements will be maintained. Furthermore, it is ensured that any accidental or erroneous detachment of the connection will be reliably prevented by a simple axial movement followed by a rotary movement and another subsequent axial movement, while enabling rapid and safe connection and detachment by the relatively coordinated actuating and moving steps for the connection and detachment of the elements to be connected. Unlike with a screw connection, which not only requires extremely tight fitting of the threaded elements to be connected, but, after having used the screw connection under stress, may possibly also entail problems during the detachment of the same and, in any event, involves an accordingly high consumption of time due to the necessary multiple rotary movement of the elements relative to each other, rapid detachment and connection are ensured by the alternating axial movement and movement in the peripheral or rotational direction proposed according to the invention. Such a course of movement comprising an axial movement alternating with a rotary movement aimed for both connecting and detaching can also be readily automated.

In order to safely avoid any erroneous emergence or detachment of the connection during an undesired movement in the axial direction of the connection sites, it is provided according to a particularly preferred embodiment that a rotation by a maximum of 180° and, in particular, approximately 60° is effected between the steps of movement in the axial direction. The offset arrangement of the profiles in the region of the reception opening, which calls for a rotation between the two axial movements, ensures that a detachment of the connection merely by the axial displacement of the connected parts will be safely prevented.

To solve the object set out in the beginning, the arrangement of the initially defined kind, moreover, is essentially characterized in that an element on an end piece to be received is provided with a particularly polygonal profile capable of being inserted in a reception opening of a second element to be connected therewith and/or a connection or intermediate piece, wherein, departing from the entry end of the reception opening, the reception opening in the axial or connection direction is formed with a partial region having a profile complementary to the profile of the end piece to be received, a region having a clear cross section enlarged relative to the entry end and, following thereupon, another region having a profile adapted to the profile of the end piece to be received. Such partial regions having respectively tuned profiles can be formed on the elements to be connected in an accordingly simple and cost-effective manner and, in addition, ensure extremely simple handling during both connecting and detaching of the elements to be connected, as has already been pointed out above. It will, thus, do to provide an appropriate profile on the end piece of the element to be received, while on the receiving end of the second element partial regions separated from each other and having complementary profiles adapted to the profile of the end to be received are provided, which are separated from each other by a partial region having an accordingly enlarged clear passage cross section in order to render feasible the rotary movement between the elements to be connected.

In order to prevent the connection from being disengaged merely by an axial displacement of the two elements, it is proposed according to a preferred embodiment that the partial regions having complementary reception opening profiles adapted to the profile of the end piece to be received are designed to be mutually offset in the peripheral direction.

In order to reliably enable the rotary movement of the two elements to be connected after the first movement in the axial direction or connection direction as proposed according to the invention, it is proposed according to another preferred embodiment that the outer contours of the profile provided on the end piece to be received have a cross section enlarged relative to the cross section of the partial region of the first element following thereupon. The first element having an outer profile, thus, immediately consecutive to the connection region or end piece includes a region having an outer cross section reduced relative to the outer contours of the profile.

In order to enable simple and reliable relative rotary movement between the individual elements to be connected, between the two moving procedures each in the axial direction or direction of connection, it is proposed according to a further preferred embodiment that the intermediately located region of the reception opening having an enlarged clear cross section has a length in the axial direction or connection direction, which exceeds the axial extension of the profile of the end piece to be received. In order to ensure proper anchorage of the two elements to be connected, the end piece of the first element must be provided with an outer profile of appropriate length so as to enable also the subsequent transmission of possibly large forces, for instance, during drilling or rotary percussion drilling. By appropriately choosing a profile, an optionally short length of the outer profile will do and it is, therefore, feasible to make the portion or region to be provided for enabling rotary movement accordingly short in the region of the reception end.

In order to render feasible a profile easy to fit in, which, in addition, ensures a reliable force transmission between the individual elements to be connected by accordingly large bearing surfaces, it is proposed according to a further preferred embodiment that the profile on the end piece to be received is formed by a regular polygon. Particularly in the context of simple processing and manufacturing of the connection regions to be connected, it is proposed according to a further preferred embodiment that the polygon has a triangular cross section having rounded tips or vertices.

For a particularly simple configuration of the differently designed partial regions in the region of the reception opening of the second element or connection or intermediate piece, it is proposed according to a further preferred embodiment that the profile on the entry end of the reception opening is formed on a separate plate-shaped or disc-shaped element connected, particularly welded, with the receiving element. It is, thus, feasible in a simple manner in the region of the reception opening to form with accordingly complementary profiles the region having an enlarged clear cross section to allow for the rotary movement and, following thereupon, the region extending in the axial direction, whereupon the plate-shaped or disc-shaped element likewise having a profile complementary to said profile is fixed to the connection end or entry end of the reception opening in an offset manner in the interior of the reception opening.

While the use of an arrangement according to the invention as well as the application of the method according to the invention are feasible in a large field of application when connecting respective elements to be connected, particularly tube-shaped or rod-shaped elements, or a connection of such tube-shaped or rod-shaped elements with driving elements and/or working elements, the use of an arrangement according to the invention with a particularly extendable drill rod assembly and, in particular, a tap-hole drilling machine, is proposed according to a particularly preferred embodiment, since, as already indicated above, the particularly rapid separation or detachment of individual portions of the rod assembly will be beneficial or necessary at a rapid emergence of molten mass having a high temperature in order to at least protect the drilling machine against the emerging high-temperature molten masses.

### SHORT DESCRIPTION OF THE DRAWINGS

In the following, the invention will be explained in more detail by way of exemplary embodiments schematically illustrated in the accompanying drawing. Therein:

FIG. 1 is a schematic side view of a tap-hole drilling machine, in which an arrangement according to the invention is employed for the realization of the method according to the invention;

FIG. 2 is an enlarged illustration of an embodiment of an arrangement according to the invention for the realization of the method according to the invention, FIG. 2a depicting the state of a connection between the two elements to be connected, and FIG. 2b depicting the state of a partial detachment of the elements to be connected; and

FIG. 3 is a view of the entry side or end side of a reception opening of an arrangement according to the invention on an enlarged scale in the sense of arrow III.

### DETAILED DESCRIPTION OF PREFERRED EMBODIMENTS

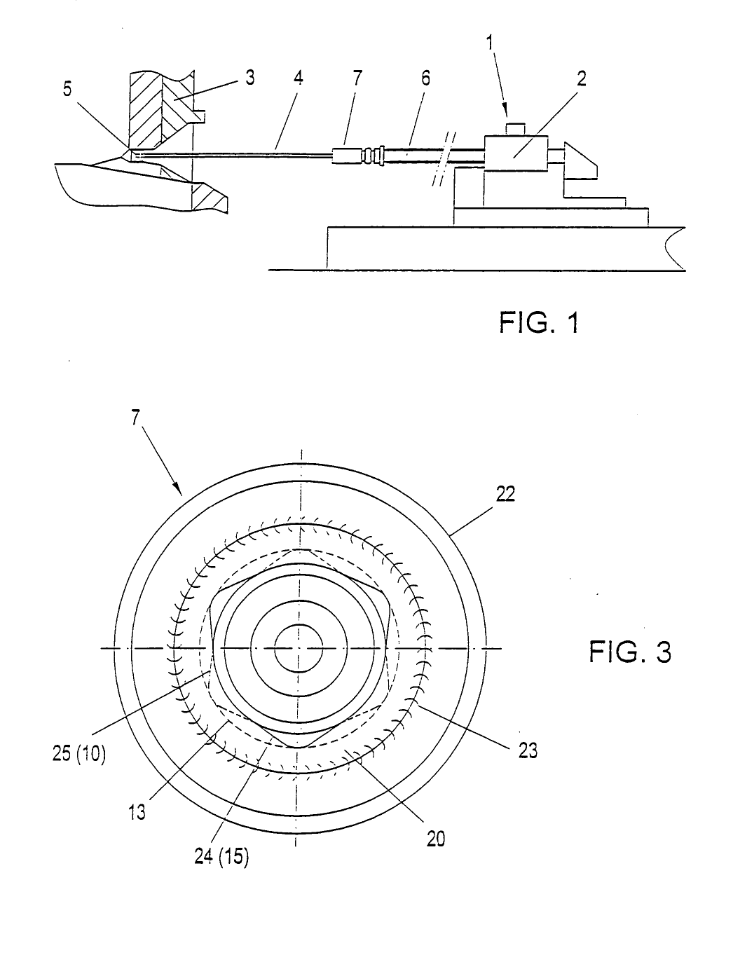

In FIG. 1, a tap-hole drilling machine, in general, is schematically denoted by 1, comprising an actuating means 2 to form a tap hole or bore hole in a blast furnace wall schematically indicated by 3, a drill bit schematically indicated by 5 being mounted on a drill rod assembly 4.

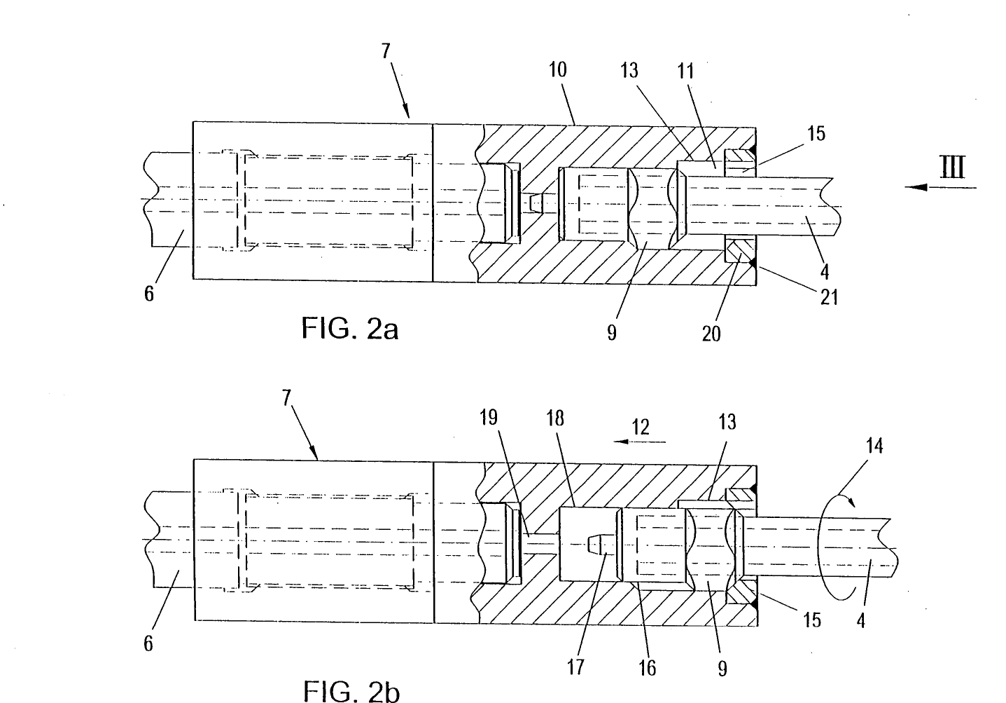

In order to fix the drill rod assembly 4 to a driven shaft 6 of the percussion and/or rotary drive of the tap-hole drilling machine 1, the drill rod assembly 4 is fixed via an intermediate element generally denoted by 7 in FIG. 1, of an arrangement for connecting the two rod-shaped or tubular elements 4 and 6, which is illustrated in more detail in FIG. 2.

In order to connect the region of the driven shaft 6 of the tap-hole drilling machine 1 with the drill rod assembly 4, the embodiment represented in FIG. 2 comprises a connection or intermediate element 7 forming said arrangement, the driven shaft 6 being firmly received in the intermediate element 7 in the left-hand partial region shown in FIG. 2.

In order to fix the drill rod assembly 4, the latter has a polygonal outer contour 9 on its front end piece facing the intermediate element 7. In the connected state depicted in FIG. 2a, the end region 9 of the drill rod assembly 4, which is provided with a polygonal outer profile, is in engagement with a partial region 10 of a reception opening generally denoted by 11, of the intermediate element 7, which partial region 10 extends in the axial direction and is provided with a complementary profile.

In order to disengage the connection between the drill rod assembly 4 and the rotary or rotary percussion drive 6 via the intermediate element 7, the intermediate element 7, as indicated in FIG. 2b, is moved away from the drill rod assembly 4 in the axial direction or connection direction according to arrow 12 such that the partial region 9 provided with an outer profile reaches a region 13 having an enlarged clear cross section, of the reception opening 11.

In the partially detached position illustrated in FIG. 2b, a relative rotation between the driven shaft 6 and the intermediate piece 7, respectively, as well as the drill rod assembly 4 in the sense of arrow 14 about an angle of, for instance, approximately 60° is effected, whereupon an axial displacement between the drill rod assembly 4 and the driven shaft 6 and the intermediate piece 7, respectively, is again effected in the sense of arrow 12, whereby the region 9 of the drill rod assembly 4, which is provided with the polygonal outer contour passes a further region 15 of the reception opening 11, which, again adapted to the polygon-shaped outer cross section of the partial region 9 of the drill rod assembly 4, comprises an accordingly polygon-shaped profile as illustrated in FIG. 3. In order to ensure enhanced centering of the drill rod assembly 4 in the region of the intermediate element 7, a substantially cylindrical region 16 as well as a centering pin 17 following the partial region 9 provided with the polygon-shaped profile are clearly apparent, in particular, from FIG. 2b, which enter an accordingly cylindrical portion 18 and a centering opening 19, respectively, in the connected state.

As is apparent from FIG. 2, partial region 15, which has again a polygonal complementary profile, is formed on a plate-shaped or disc-shaped element 20 which is welded with the intermediate element 7 in the region of the end face 21 of the reception opening 11.

FIG. 3 clearly depicts the relative position of the different polygonal profiles in the region of the fixation of the two elements to be connected. The outer contour of the intermediate element 7 is indicated by 22, the welding zone on the end side of the plate-shaped element 20 being indicated by 23. The plate-shaped element 20 comprises a polygonal profile 24 corresponding to the partial region 15, the profile 24 corresponding to the outer contour of the partial region 9 of the drill rod assembly 4. The partial region 20 having the profile 24 is followed by the partial region that has an enlarged clear cross section and whose contour is denoted by 13 as in correspondence with FIG. 2, so as to enable the free rotability of the drill rod assembly 4 and, in particular, of the partial region 9 provided with the polygon as the partial region 9 of the drill rod assembly 4 passes the partial region 15 having the polygonal contour 24. After a rotation by about 60°, the partial region 9 having a polygonal outer section enters the partial region following in the axial direction and again having a polygonal contour, the second polygonal contour being denoted by 25 as in correspondence with the region 10 of the intermediate element.

From FIG. 3 it is apparent that the offset arrangement of the two polygons 24 and 25 prevents the erroneous emergence from the connection zone even at an accidental axial displacement between the elements 4 and 6 to be connected.

From FIG. 3, it is furthermore apparent that the polygon-shaped contour is, for instance, formed by a triangular polygon having rounded tips or vertices each. It goes without saying that, instead of fixing via an intermediate piece 7 the elements 4 and 6 to be connected, one of the elements may be formed with an appropriate reception opening having differently shaped partial regions corresponding to the intermediate or connection piece 7 so as to produce the arrangement for a rapid and easy detachment and connection of the two elements 4 and 6 to be connected.

Instead of fixing a drill rod assembly 4 to a driving shaft 6, as illustrated in the preceding Figures, the arrangement illustrated for a rapid connection and detachment may also serve to connect individual tube-shaped or rod-shaped elements, for instance when extending a drill rod assembly 4, or it is feasible to fix, for instance, a drill rod assembly 4 to a drill bit 5 according to the arrangement or connection to be rapidly and readily detached or connected.

In addition to a configuration having a substantially triangular polygonal structure with rounded vertices, any other substantially symmetric or regular polygonal structure may, of course, be chosen, the angle of rotation between the elements to be connected being tuned to the mutual angular distance of individual vertices or tips of the polygonal connection.

1. A method for the rapid connection and detachment of connectable elements, particularly tubes or rods and/or driving elements and/or working elements capable of being fixed thereto such as, for instance, drill bits or the like, wherein an element having a profiled end piece is introduced into a respective reception opening of the element to be connected therewith and/or an intermediate or connection piece, particularly a bushing or sleeve, and connected with the second element in a positive and force-transmitting manner, wherein, for the connection and detachment of the two elements to be connected, the profiled end piece after a movement in the axial or connection direction is rotated, by a partial region of the reception opening provided with a profile complementary to that of the end piece, relative to the reception opening in a partial region of the reception opening having an enlarged clear cross section and subsequently is again moved in the axial direction into a further partial region of the reception opening provided with a profile complementary to that of the end piece.

2. A method according to claim 1, wherein a rotation by a maximum of 180° and, in particular, approximately 60° is effected between the steps of movement in the axial direction.

3. An arrangement for the rapid connection and detachment of connectable elements, particularly tubes or rods and/or driving elements and/or working elements capable of being fixed thereto such as, for instance, drill bits or the like, wherein an element having a profiled end piece is introducible into a respective reception opening of the element to be connected therewith and/or an intermediate or connection piece, particularly a bushing or sleeve, and connectable with the second element in a positive and force-transmitting manner, wherein an element on an end piece to be received is provided with a particularly polygonal profile capable of being inserted in a reception opening of a second element to be connected therewith and/or a connection or intermediate piece, wherein, departing from the entry end of the reception opening, the reception opening in the axial or connection direction is formed with a partial region having a profile complementary to the profile of the end piece to be received, a region having a clear cross section enlarged relative to the entry end and, following thereupon, another region having a profile adapted to the profile of the end piece to be received.

4. An arrangement according to claim 3, wherein the partial regions having complementary reception opening profiles adapted to the profile of the end piece to be received are designed to be mutually offset in the peripheral direction.

5. An arrangement according to claim 3, wherein the outer contours of the profile provided on the end piece to be received have a cross section enlarged relative to the cross section of the partial region of the first element following thereupon.

6. An arrangement according to claim 3, wherein the intermediately located region of the reception opening having an enlarged clear cross section has a length in the axial direction or connection direction, which exceeds the axial extension of the profile of the end piece to be received.

7. An arrangement according to claim 3, wherein the profile on the end piece to be received is formed by a regular polygon.

8. An arrangement according to claim 7, wherein the polygon the polygon has a triangular cross section having rounded tips or vertices.

9. An arrangement according to claim 3, wherein the profile on the entry end of the reception opening is formed on a separate plate-shaped or disc-shaped element connected and, in particular, welded with the receiving element.

10. The use of an arrangement for the rapid connection and detachment of connectable elements according to claim 3 with a particularly extendable drill rod assembly and, in particular, a tap-hole drilling machine.
